(19) United States
(12) Patent Application Publication
(10) Pub. No.: US 2008/0227599 A1
(43) Pub. Date: Sep. 18, 2008

(54) Automatic transmission control device

(75) Inventor: Akira TAKAGI, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/071,064

(22) Filed: Feb. 14, 2008

(30) Foreign Application Priority Data
Feb. 20, 2007 (JP) 2007-38836

(51) Int. Cl. B60W 10/10; G06F 19/00

(52) U.S. Cl. 477/115; 701/51

(57) ABSTRACT

In an automatic transmission control device, multiple electromagnetic valves control fluid pressure of working fluid to be applied to multiple friction elements of an automatic transmission device, so that a transmission gear is changed by engaging some of the friction gears and/or disengaging the other of the friction elements. The electromagnetic valve controls its output pressure in such a manner that the output pressure is temporally increased when starting the transmission gear change. A maximum fluid pressure is selected from the output pressures of the multiple electromagnetic valves and is applied to a pressure control valve, which controls a fluid control pressure applied to a capacity varying device for changing a discharge amount of a pump. As a result, the fluid pressure applied to the friction elements can be rapidly increased at proper timings.

### CROSS REFERENCE TO RELATED APPLICATION

This application is based on Japanese Patent Application No. 2007-38836, which is filed on Feb. 20, 2007, the disclosure of which is incorporated herein by reference.

### FIELD OF THE INVENTION

The present invention relates to an automatic transmission control device for hydraulically controlling a transmission mechanism of an automatic transmission device for a vehicle.

### BACKGROUND OF THE INVENTION

An automatic transmission control device is known in the art, for example, as disclosed in the following Japanese Patent Publications:

JP 2003-254420

JP 2005-127435

JP H5-312250

In the above automatic transmission control device, oil pressure to be applied to friction elements, such as clutches and brakes, which form a transmission mechanism of an automatic transmission device, is controlled so that a transmission gear is changed by bringing the friction elements into engagement while bringing other friction elements out of the engagement.

In the automatic transmission control device disclosed in JP 2003-254420, an input pressure for a primary valve is adjusted by an electromagnetic valve (working as an input pressure adjusting device), so that oil pressure (line pressure) for a hydraulic pressure line generated by the primary valve is controlled by such input pressure. However, according to such a structure, a special electromagnetic valve is necessary in addition to the primary valve in order to generate the oil pressure (the line pressure) for the hydraulic pressure line. Accordingly, a number of parts is increased, and size and cost for the automatic transmission control device are increased.

According to the automatic transmission control device, as disclosed in JP 2005-127435, oil pressure to be applied to respective friction elements is controlled by respective electromagnetic valves, and the maximum oil pressure is selected among those output pressures of the electromagnetic valves, wherein the maximum oil pressure is used as a command pressure to a line pressure control valve for generating the oil pressure (the line pressure) for the hydraulic pressure line. According to such a structure, a special electromagnetic valve is no longer necessary for generating the line pressure by the line pressure control valve.

However, according to such a structure, as disclosed in the above JP 2005-127435, in which the line pressure control valve is used to generate the line pressure in accordance with the command pressure by adjusting a discharge amount of working fluid discharged from a pump, the line pressure control valve may become larger in size, because the discharge amount of the pump becomes larger as an engine rotational speed is increased and the line pressure control valve has to cope with such large amount of the working fluid from the pump. Furthermore, such large amount of the working fluid is supplied into the line pressure control valve, a cross-sectional area of a passage for connecting the pump to the line pressure control valve becomes larger. Accordingly, the line pressure control valve as well as its connected passage is increased in size.

In the automatic transmission control devices, such as disclosed in the above Japanese Patent Publication No. JP 2003-254420 and No. JP 2005-127435, the discharge amount of the pump is primarily decided by the rotational speed of the engine. Therefore, the discharge amount of the pump may come short or may be overproduced with respect to a demanded flow amount of the automatic transmission, in a certain range of the engine rotational speed. As a result, an appropriate oil pressure may not be applied to the friction elements at necessary timings required by the automatic transmission.

In the automatic transmission control device, as disclosed in JP Patent Publication No. H5-312250, a vane pump of a capacity variable type is used so that the discharge amount of the pump may be controlled independently of the engine rotational speed.

According to such automatic transmission control device, however, a hydraulic actuator (including an electromagnetic valve, a pressure decreasing valve, and so on) is additionally necessary for changing an eccentric amount of the vane pump of the capacity variable type to control the discharge amount of the pump. Accordingly, a number of parts is increased to increase manufacturing cost. Furthermore, an appropriate amount of the working oil may not be supplied to the automatic transmission at appropriate timings, even when the eccentric amount of the pump is controlled. This is because there is variation of response between the electromagnetic valve for controlling the eccentric amount of the pump and the electromagnetic valves for controlling oil pressures to be applied to the friction elements of the automatic transmission. As above, it is a problem that an appropriate pressure may not be applied to the automatic transmission at the necessary timings.

### SUMMARY OF THE INVENTION

The present invention is made in view of the above problems. It is an object of the present invention to provide an automatic transmission control device, according to which appropriate oil pressure can be applied to friction elements of an automatic transmission device at appropriate timings, and a number of parts for the automatic transmission device can be reduced and a size of the device becomes smaller.

According to a feature of the present invention, fluid pressure is applied to multiple friction elements of an automatic transmission device in accordance with discharge pressure of a pump for changing a transmission gear, and a maximum pressure is selected among output pressures of multiple electromagnetic control devices. A capacity varying device is operated by fluid control pressure to change the discharge pressure and the discharge amount of the pump, wherein the fluid control pressure is adjusted by a line pressure control device in accordance with the selected maximum pressure.

According to such a structure, it is not necessary to provide a special electromagnetic valve to apply a command pressure (corresponding to the above selected maximum pressure) to the line pressure control device. Furthermore, it is not necessary to provide a special electromagnetic valve for controlling the discharge amount of the pump, because the fluid control pressure applied to the capacity varying device is adjusted by the line pressure control device. As above, according to the present invention, a number of parts for forming a hydraulic circuit, which generates the fluid pressure applied to the friction elements as well as the fluid control pressure applied to the capacity varying device and so on, can be reduced, so that the automatic transmission device can be made smaller in size and lower in cost.

According to another feature of the present invention, the discharge amount of the pump is controlled by the maximum pressure, which is selected from the output pressures of multiple electromagnetic control devices. As a result, an amount of working fluid which is controlled by the line pressure control device for controlling the discharge pressure of the pump can be reduced. Accordingly, parts and material for forming the line pressure control device as well as pressure lines connected to the line pressure control device can be made smaller in size.

Furthermore, the line pressure as well as the fluid control pressure to be applied to the capacity varying device for changing the discharge amount of the pump is controlled by the same line pressure control device. As a result, the discharge amount of the pump can be increased or decreased at proper timings so that necessary amount of the working fluid necessary for engagement or disengagement of the friction elements can be obtained. Namely, the proper fluid pressure can be applied to the friction elements at the proper timings.

According to a further feature of the present invention, an electronic control device controls the electromagnetic control device, such that the output pressure of the electromagnetic control device is temporally increased when starting a transmission gear change. When the electronic control device controls to temporally increase the output pressure of the electromagnetic control device, the maximum pressure selected among the output pressures of the electromagnetic control devices is also rapidly increased, and the discharge amount of the pump is correspondingly increased in accordance with the increase of the maximum pressure. Accordingly, the fluid pressure to be applied to the friction elements can be rapidly increased at proper timing during a period of transmission gear change operation, in particular during an initial period of the gear change operation in which clutches are brought into engagement by filling a clutch chamber thereof with the working fluid. Namely, a time period for filling the clutch chamber with the working fluid can be shortened.

According to a further feature of the present invention, the electronic control device also controls the electromagnetic control device such that the output pressure of the electromagnetic control device is temporally increased when starting engagement of a lock-up clutch. Accordingly, the lock-up clutch can be rapidly engaged as in the same manner to the friction elements.

According to a still further feature of the present invention, the electronic control device controls the electromagnetic control device such that the output pressure thereof is increased, when temperature of the working fluid becomes lower than a predetermined value. Therefore, even when viscosity of the working fluid is high due to a low temperature, the fluid pressure to be applied to the friction elements can be smoothly increased.

According to a still further feature of the present invention, the electronic control device controls the electromagnetic control device such that the output pressure thereof is increased, when rotational number of an internal combustion engine is lower than a predetermined value. The discharge amount of the pump is reduced when the rotational speed of the engine becomes lower. However, according to such an arrangement, even when the rotational speed of the engine becomes lower, the fluid pressure to be applied to the friction elements can be smoothly increased.

According to a still further feature of the present invention, an operational speed of the capacity varying device, which changes the discharge amount of the pump, is decreased so that a rapid change of the discharge amount of the pump can be prevented.

According to a still further feature of the present invention, a relief valve is provided in a pump discharge line, into which the pump discharges the pressurized working fluid. The relief valve is operated (opened) when the discharge pressure of the pump exceeds a predetermined value, so that the fluid pressure in the pump discharge line may not become higher than such predetermined value. As a result, damages at parts and components for the hydraulic circuit can be prevented.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a hydraulic circuit of an automatic transmission control device according to a first embodiment of the present invention;

FIG. 2 is a schematic view showing a hydraulic circuit for a torque converter and a lock-up clutch;

FIG. 3 is a graph showing a change of clutch pressure when a clutch is engaged; and

FIG. 4 is a schematic view showing a hydraulic circuit of an automatic transmission control device according to a second embodiment of the present invention.

### DETAILED DESCRIPTION OF THE PREFERRED EMBODIMENTS

### First Embodiment

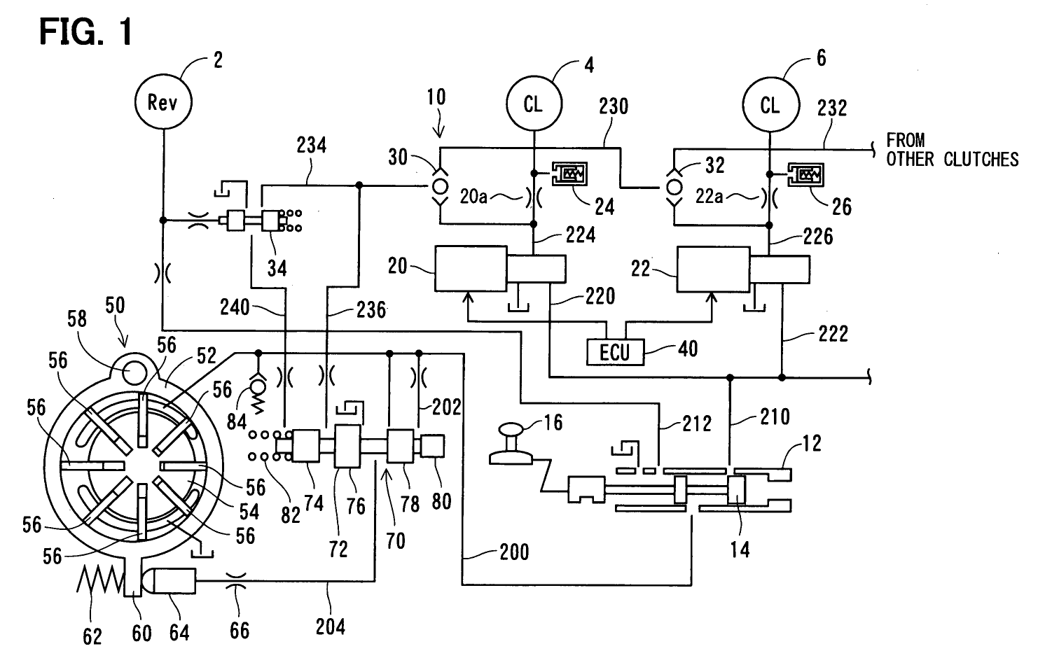

An automatic transmission control device according to a first embodiment of the present invention will be explained with reference to FIG. 1.

In FIG. 1, a reverse clutch 2, a clutch 4, another clutch 6 and other clutches not shown in the drawing as well as brakes also not shown in the drawing are friction elements, each of which is engaged or released (disengaged) by hydraulic pressure to change a transmission gear.

A spool 14 of a manual valve 12 is moved back and forth when a shift range is changed by a driver via a shift lever 16, so that a communication between a hydraulic pressure line 200 and a pressure line 210 for a forward movement is changed to a communication between the hydraulic pressure line 200 and a pressure line 212 for a backward movement, or vice versa. A pressurized working fluid (working oil) is discharged from a pump 50 into the hydraulic pressure line 200. A discharge fluid pressure of the pump 50 is applied to a line pressure control valve 70 through an output line 202, which is bifurcated from the hydraulic pressure line 200. Pressure lines 220 and 222 are bifurcated from the pressure line 210 for the forward movement and connected to respective friction elements (4, 6), each of which is engaged (or released) depending on a selected transmission gear for the forward movement. The pressure line 212 for the backward movement is connected to the reverse clutch 2.

When a shift range D (the forward movement) is selected by the shift lever 16, the hydraulic pressure line 200 is connected to the pressure line 210 for the forward movement, whereas the hydraulic pressure line 200 is connected to the pressure line 212 for the backward movement when a shift range R (the backward movement) is selected by the shift lever 16. When the working oil is supplied to the pressure line 212, a reverse-shift valve 34 is operated such that a pressure line 234 and a pressure line 240 are connected to each other. As a result, oil pressure is applied to an axial end surface of a rand 74, which is a side of a spring 82, of the line pressure control valve 70. Then, a spool 72 is moved in a direction (in a right-hand direction in FIG. 1), in which a spring reaction force is applied to the rand 74, to thereby increase the oil pressure in the output pressure line 202 of the line pressure control valve 70 which is connected to the hydraulic pressure line 200. Accordingly, the oil pressure in the hydraulic pressure line 200 when the shift range R for the backward movement is selected becomes higher than the oil pressure in the hydraulic pressure line 200 when the shift range D for the forward movement is selected. In other words, the oil pressure applied to the reverse clutch 2 when the shift range R for the backward movement is selected by the shift lever 16 is higher than the oil pressure applied to the clutches 4 and 6 when the shift range D for the forward movement is selected by the shift lever 16.

Electromagnetic valves (electromagnetic control devices) 20 and 22 control oil pressure in the pressure lines 220 and 222 bifurcated from the pressure line 210 for the forward movement, and such controlled oil pressure (also referred to as an output pressure of the electromagnetic valve) is applied to the clutches 4 and 6 via pressure lines 224 and 226. The electromagnetic valves 20 and 22 are controlled by a duty-ratio control operation or electric current value of a driving current, in order to control the oil pressure to be applied to the clutches 4 and 6. Dampers 24 and 26 not only decrease pressure pulsation in the pressure lines 224 and 226, but also function as a buffering device for preventing over-shooting or under-shooting of the oil pressure in a clutch chamber for the clutches 4 and 6 when the transmission gear is changed.

A high pressure selection valve (a selection device) 32 selects a higher oil pressure between the oil pressure in a pressure line 232 and the oil pressure in the pressure line 226, and such selected higher oil pressure is applied to a pressure line 230. The oil pressure in the pressure line 226 is controlled by the electromagnetic valve 22 and is applied to the clutch 6 through a fixed orifice 22a. The oil pressure selected by another high pressure selection valve (not shown) for the other clutches (not shown) is applied to the pressure line 232. A high pressure selection valve (a selection device) 30 selects, in a similar manner to the valve 32, a higher oil pressure between the oil pressure in the pressure line 230 and the oil pressure in the pressure line 224, and such selected higher oil pressure is applied to the pressure line 234. The oil pressure in the pressure line 224 is controlled by the electromagnetic valve 20 and is applied to the clutch 4 through a fixed orifice 20a. Namely, the oil pressure thus selected and applied to the pressure line 234 is the maximum high pressure among the oil pressures to be applied to the friction elements including the clutches 4 and 6 and other clutches (not shown), except for the friction element for the reverse clutch 2. In other words, the maximum high pressure is selected among the output pressures of the electromagnetic valves 20 and 22. The maximum high pressure in the pressure line 234 is applied to the line pressure control valve 70 via a maximum pressure line 236, which is bifurcated from the pressure line 234.

An electronic control unit (ECU) 40 controls, as an oil pressure control device, the electromagnetic valves 20 and 22 in accordance with engine operational condition, to control the oil pressures to be applied to the clutches 4 and 6.

The pump 50 is a vane pump of a capacity variable type, wherein a rotor 54 is rotatably accommodated in a cam ring 52. Multiple vanes 56 are radially arranged at the rotor 54, such that the vanes 56 move back and forth in a radial direction in accordance with rotation of the rotor 54. The cam ring 52 is pivotally supported by a shaft 58 and controlled to be at a position, at which the cam ring 52 is eccentric from the rotor 54. Depending on an eccentric amount of such eccentric position of the cam ring 52 to the rotor 54, a pressurizing volume of the pump 50, that is a discharge amount of the pump 50 is increased or decreased.

One end of a spring 62 is in contact with a projection 60 of the cam ring 52 to bias the cam ring 52 in a circumferential direction, whereas a control pressure is applied from the line pressure control valve 70 to a capacity control piston (a capacity changing device) 64 via a control pressure line 204. The capacity control piston 64 pushes the projection 60 in an opposite direction to a biasing direction of the spring 62 in accordance with the control pressure from the control pressure line 204. The cam ring 52 is pivoted at the shaft 58 to such an eccentric position, at which a balance is kept between the biasing force of the spring 62 and the pushing force of the capacity control piston 64. An orifice 66 is provided in the control pressure line 204 as an operation decreasing device, which prevents a rapid change of the control pressure to be applied from the line pressure control valve 70 to the capacity control piston 64 to decrease a moving speed of the capacity control piston 64.

When the rotor 54 is rotated in accordance with rotation of an internal combustion engine, the vanes 56 move back and forth in the radial direction depending on the eccentric amount of the cam ring 52 to the rotor 54, so that the working fluid (oil) sucked from a drain is pressurized and discharged into the hydraulic pressure line 200. The discharge amount of the pump 50 is increased or decreased depending on the eccentric amount of the cam ring 52 to the rotor 54. The discharge amount of the pump 50 is higher, as the eccentric amount of the cam ring 52 to the rotor 54 is larger, namely as the oil pressure applied to the capacity control piston 64 from the line pressure control valve 70 via the control pressure line 204 is higher.

The spool 72, which is a pressure adjusting device, is moved to such a position, at which a balance is kept among a biasing force of the spring 82 and pushing forces at respective rand 74, 76, 78, 80 applied by the oil pressures from the output pressure line 202, the maximum pressure line 236 and the pressure line 240 for the backward movement. The spool 72 controls the oil pressures in the hydraulic pressure line 200 and the control pressure line 204. A direction of the pushing force at a pressure receiving surface of the rand 78, to which the pump discharge pressure of the pump 50 is applied from the hydraulic pressure line 200 via the output line 202, is opposite to a direction of the pushing force at a pressure receiving surface of the rand 76, to which the maximum oil pressure is applied from the maximum pressure line 236. As already explained, the maximum oil pressure is the selected maximum oil pressure among the oil pressures controlled by the electromagnetic valves 20 and 22 and to be applied to the friction elements (except for the friction element for the clutch of the backward movement) for the clutches 4 and 6 and other clutches (not shown).

A relief valve 84 is provided in the hydraulic pressure line 200, into which the working oil is discharged from the pump 50. The relief valve 84 is opened when the oil pressure in the hydraulic pressure line 200 becomes higher than a predetermined value, to decrease the oil pressure in the hydraulic pressure line 200. Accordingly, a rapid increase of the oil pressure in the hydraulic pressure line 200 is prevented during an operation for changing the transmission gear, as explained below.

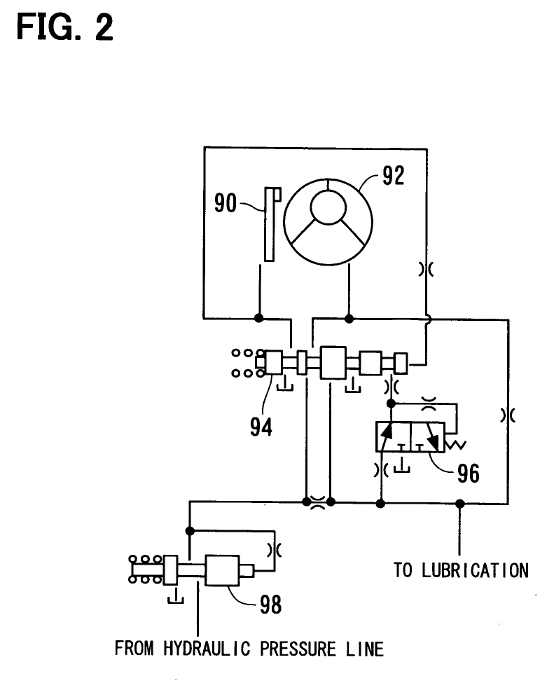

In FIG. 2, a lock-up clutch 90 connects or disconnects an output shaft of the engine to or from an input shaft of the automatic transmission device. When the lock-up clutch 90 is engaged, the lock-up clutch 90 transmits a driving force from the engine to the automatic transmission, wherein a torque converter 92 is bypassed. A lock-up relay valve 94 switches an engaged condition to a disengaged (released) condition, or vice versa, of the lock-up clutch 90, in accordance with a command pressure from an electromagnetic valve 96. A lock-up clutch control valve 98 controls the oil pressure to be applied to the lock-up clutch 90.

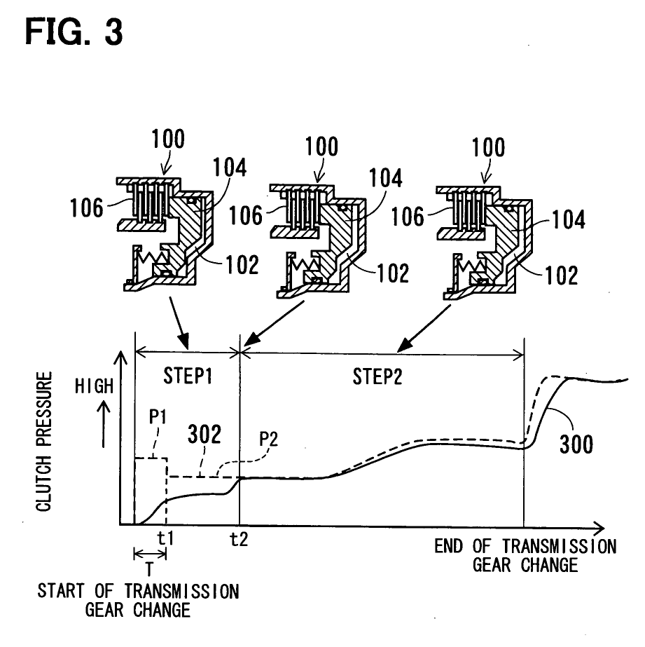

A change of clutch pressure (the oil pressure applied to the clutch) when the transmission gear is changed will be explained. FIG. 3 shows the change of clutch pressure, when a clutch 100 which is in a released (disengaged) condition is brought into engagement for changing the transmission gear. FIG. 3 schematically shows the clutch 100, which corresponds to a structure of the clutches 4 and 6 shown in FIG. 1.

In FIG. 3, a solid line 300 shows the oil pressure in a clutch chamber 102 of the clutch 100. The oil pressure in the clutch chamber 102 is obtained as a result that the oil pressure in the pressure line 210 for the forward movement is respectively controlled by the electromagnetic valves 20 and 22 and such controlled oil pressure is supplied to the respective clutch chambers 102 of the clutches 4 and 6 via the fixed orifices 20a and 22a. Accordingly, it is necessary to control the output pressure of the electromagnetic valves 20 and 22 (the oil pressure in the pressure lines 224 and 226 between the electromagnetic valves 20 and 22 and the fixed orifices 20a and 22a) as shown by a dotted line 302 in FIG. 3, in order to achieve the clutch pressure of the clutch chamber 102 shown by the solid line 300. In other words, the dotted line 302 is a target oil pressure of the output pressure for the electromagnetic valves 20 and 22, which are controlled by control signals from the ECU 40, and it is also the target oil pressure for the electromagnetic valves 20 and 22 in order to achieve the oil pressure for the clutch chamber 102 as shown by the solid line 300.

An operation of a first period “STEP 1” in FIG. 3 will be explained. When the automatic transmission device starts a transmission gear change, ECU 40 outputs the control signal to the electromagnetic valves 20 and 22, so that the controlled oil pressure at the electromagnetic valves 20 and 22 (i.e. the output pressure of the electromagnetic valves) is temporally increased as indicated by the dotted line 302, in order that the oil pressure of the clutch chamber 102 is increased as indicated by the solid line 300. As shown in FIG. 3, the output pressures of the electromagnetic valves 20 and 22 are increased to a first pressure “P1” during a short period “T”. As a result, the maximum oil pressure selected from the electromagnetic valves 4 and 6 and other electromagnetic valves (not shown) is increased. Namely, the control pressure to be applied from the line pressure control valve 70 to the capacity control piston 64 is increased, to thereby increase the discharge amount of the pump 50. Then, the amount of the working oil to be supplied to the clutch chamber 102 is increased to quickly fill the clutch chamber 102 with the working oil. When the clutch chamber 102 is filled with the working oil and the oil pressure in the clutch chamber 102 is thereby increased, a clutch piston 104 starts its movement.

When the clutch piston 104 is moved to be closer to a clutch plate 106 (at a timing “t1”), ECU 40 controls the electromagnetic valves to decrease the controlled pressure at the electromagnetic valves in accordance with the decrease of the target oil pressure, namely from the first pressure “P1” to a second pressure “P2”. This is to prevent the clutch piston 104 from strongly hitting against the clutch plate 106 when the clutch piston 104 is moved closer to the clutch plate 106. When the target oil pressure is decreased from the first pressure “P1” to the second pressure “P2”, an increasing speed of the oil pressure supplied to the clutch chamber 102 becomes lower, so that the movement of the clutch piston 104 slows down to softly hit against the clutch plate 106. As above, the clutch piston 104 softly hits against the clutch plate 106 and is brought into engagement therewith around a boundary (a timing “t2”) between operational periods of “STEP 1” and “STEP 2” in FIG. 3. When the clutch piston 104 is engaged with the clutch plate 106, the oil pressure in the clutch chamber 102 may be rapidly increased, because the volume of the clutch chamber 102 is not further expanded. According to the present invention, therefore, the dampers 24 and 26 are provided in the pressure lines 224 and 226, to prevent over-shooting of the oil pressure in the clutch chamber 102.

An operation of the second period “STEP 2” in FIG. 3 will be explained. ECU 40 outputs the control signal to the electromagnetic valves 20 and 22 to further increase the controlled pressure at the electromagnetic valves so that the oil pressure to be applied to the clutch piston 104 will be gradually increased, in order to completely engage the clutch plates 106 with each other after the clutch piston 104 is engaged with the clutch plate 106. The oil pressure applied to the clutch piston 104 is increased to such a value close to a limit, at which the clutch plates 106 do not slip from each other, and the change of the transmission gear ends.

When the operation of the STEP 2 ends after the transmission gear change is completed, ECU 40 controls the electromagnetic valves 20 and 22 to increase the controlled pressure thereof to a predetermined value, so that the engaged clutch plates 106 may not slide from each other.

The above control (the operations in the STEP 1 and STEP 2) for smoothly engaging the clutch while decreasing engaging shock during the transmission gear change will be likewise carried out for engaging the lock-up clutch 90 shown in FIG. 2. Namely, when the lock-up clutch 90 starts with its engagement, ECU 40 controls the electromagnetic valves 20 and 22 to temporally increase their output pressure. The discharge amount of the pump 50 is increased by the maximum oil pressure in the maximum oil pressure line 236, so that the working oil is quickly supplied into a clutch chamber of the lock-up clutch 90. As a result, the lock-up clutch 90 is quickly engaged.

According to the above explained first embodiment, the maximum oil pressure is selected among the output pressures controlled by the electromagnetic valves 20 and 22 and other electromagnetic valves (not shown), wherein the electromagnetic valves control the oil pressure to be applied to the friction elements, such as the clutches 4 and 6. Then, the discharge pressure (the discharge amount) of the pump 50 is controlled by the line pressure control valve 70 depending on the above selected maximum oil pressure. As a result, a number of parts can be reduced, when compared with such a system in which the line pressure control valve 70 receives a command pressure from a special electromagnetic valve to control the discharge pressure (amount) of the pump 50. The automatic transmission control device 10 can be reduced in its size and in manufacturing cost.

In the pump 50 of the capacity variable type, the eccentric amount is controlled to vary the discharge amount of the pump 50, and the oil pressure to be applied to the capacity control piston 64 is controlled by the line pressure control valve 70 depending on the maximum oil pressure. Accordingly, a number of parts for the pump 50 can be reduced when compared with such a pump, in which the eccentric amount is adjusted by an electromagnetic valve.

The discharge amount of the pump 50 is also controlled depending the maximum oil pressure, which is selected from the output pressures controlled by the electromagnetic valves 20 and 22 and other electromagnetic valves (not shown) for controlling the oil pressures to be applied to the friction elements. Therefore, the amount of the working oil, which is operated by the line pressure control valve 70 for controlling the output (discharge) pressure of the pump 50, is small. Accordingly, parts and material for forming the line pressure control valve 70 and the pressure lines, which connect the line pressure control valve 70 with the other components (such as the pump 50), can be made smaller.

Furthermore, not only the discharge pressure (amount) of the pump 50 but also the oil pressure applied to the capacity control piston 64 for controlling the discharge amount of the pump 50 is controlled by the one line pressure control valve 70. Therefore, necessary amount of the working oil can be supplied to the automatic transmission device at appropriate timings during the operations for the transmission gear change and the control for the engagements of the lock-up clutch 90, as explained in FIG. 3. For example, the output oil pressure of the electromagnetic valves is temporally increased to increase the amount of the working oil to be filled into the clutch chamber 102 at starting the engaging operation of the transmission gear. The discharge amount of the pump is generally reduced, when the rotational speed of the engine is low or when viscosity of the working oil is high because of low temperature. However, according to the invention, the discharge amount of the pump 50 is increased by increasing the eccentric amount, even when the rotational speed of the engine is low or viscosity of the working oil is high because of low temperature, so that the oil pressure to be applied to the friction elements can be quickly increased.

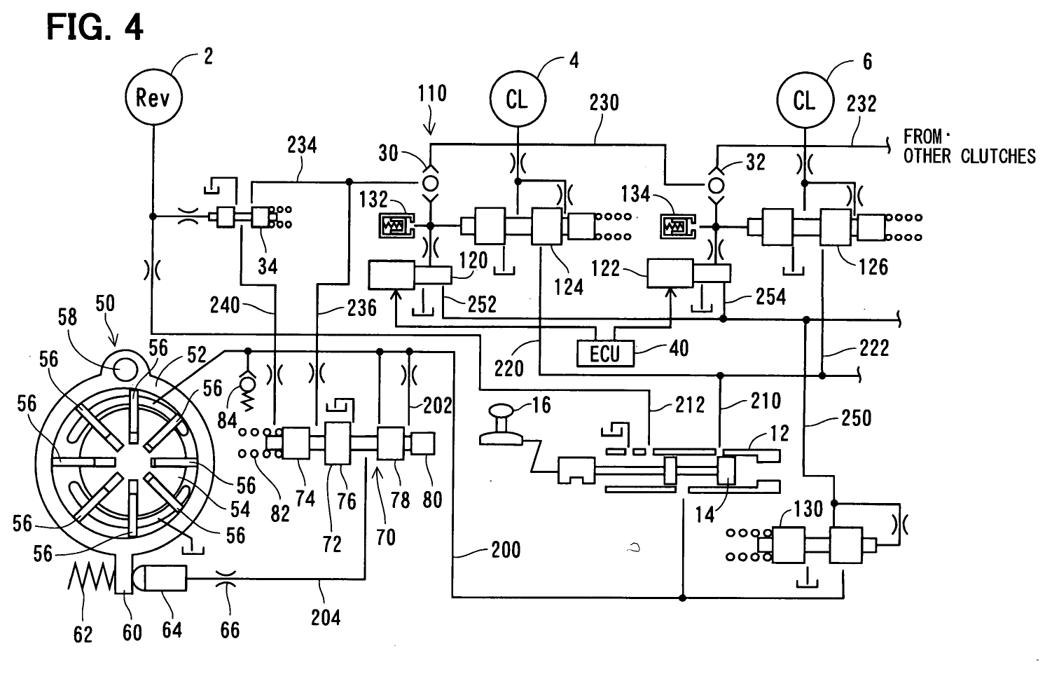

A second embodiment of the present invention will be explained with reference to FIG. 4.

In the automatic transmission control device 110 of the second embodiment, the oil pressure applied to the clutches 4 and 6 is controlled by electromagnetic valves 120 and 122 and pressure control valves 124 and 126, wherein command pressures are applied from the electromagnetic valves 120 and 122 to the pressure control valves 124 and 126. A modulating valve 130 is provided in a pressure line bifurcated from the hydraulic pressure 200, to decrease the oil pressure of the hydraulic pressure 200 to generate a modulated pressure, which is applied to the electromagnetic valves 120 and 122 via modulated pressure lines 250, 252 and 254. The oil pressure of the hydraulic pressure line 200, which is controlled by the line pressure control valve 70, is applied to the pressure control valves 124 and 126 via the manual valve 12 and the pressure lines 210, 220 and 222 for the forward movement. The high pressure selection valves 30 and 32 select the maximum oil pressure from the output pressures of the electromagnetic valves 120 and 122, which are applied to the pressure control valves 124 and 126.

According to the second embodiment, the command pressure is applied from the electromagnetic valves 120 and 122 to the pressure control valves 124 and 126, which are operated by the basic pressure (the modulated pressure) generated from the oil pressure in the hydraulic pressure line 200 by decreasing oil pressure at the modulating valve 130. And the oil pressure applied to the clutches 4 and 6 is generated and controlled by the pressure control valves 124 and 126. Accordingly, the electromagnetic valves 120 and 122 can be made smaller in size than those of the first embodiment.

The dampers 132 and 134 are provided on the output sides of the electromagnetic valves 120 and 122. Therefore, the amount of the working oil, which is used by the dampers 132 and 134 as buffering devices, is reduced compared with the first embodiment. The dampers 132 and 134 can be, therefore, reduced in size.

In the above embodiments, the relief valve 84 is provided in the hydraulic pressure line 200 for the purpose of preventing the rapid increase of the oil pressure of the working oil discharged from the pump 50. The relief valve 84 may be eliminated.

In the above embodiments, the orifice 66 is provided in the control pressure line 204 for applying the control pressure from the line pressure control valve 70 to the capacity control piston 64, in order to prevent the rapid change of the control pressure applied to the capacity control piston 64 and thereby to prevent the rapid change of the discharge amount of the pump 50. The orifice 66, however, may be eliminated from the pressure control line 204.

The present invention may not be limited to the above mentioned embodiments, but any other modifications can be possible without departing from the spirit of the invention.

What is claimed is:

1. An automatic transmission control device for a vehicle comprising:
an automatic transmission mechanism having multiple friction elements, wherein a transmission gear is changed by bringing some of the friction elements into engagement and/or bringing the other of the friction elements out of engagement by controlling fluid pressure of working fluid to be applied to the friction elements;
a pump being driven by an internal combustion engine for pressurizing and discharging the working fluid to generate fluid pressure applied to the friction elements;
a capacity varying device operated by fluid control pressure to change discharge amount of the pump;
multiple electromagnetic control devices for controlling the fluid pressure to be applied to the friction elements in accordance with discharge pressure of the pump;
a selection device for selecting maximum pressure among output pressures of the electromagnetic control devices; and
a pressure control device for receiving the discharge pressure of the pump and controlling the fluid pressure in accordance with the selected maximum pressure of the electromagnetic control devices, wherein the discharge pressure of the pump is controlled and the capacity varying device is operated by the fluid pressure such controlled.

2. An automatic transmission control device according to claim 1, wherein
the pressure control device has a first pressure receiving surface for receiving the discharge pressure of the pump, and
the pressure control device has a second pressure receiving surface for receiving the selected maximum pressure of the electromagnetic control devices, in a direction opposite to that for the first pressure receiving surface.

3. An automatic transmission control device according to the claim 1, further comprising:
an electronic control device for controlling the output pressure of the electromagnetic control device.

4. An automatic transmission control device according to the claim 3, wherein
the electronic control device controls the electromagnetic control device such that the output pressure of the electromagnetic control device is temporally increased when starting a transmission gear change.

5. An automatic transmission control device according to the claim 3, wherein
the electromagnetic control device controls fluid pressure of the working fluid to be applied to a lock-up clutch, which transmits an output torque of the internal combustion engine to the automatic transmission mechanism by bypassing a torque converter, and
the electronic control device controls the electromagnetic control device such that the output pressure of the electromagnetic control device is temporally increased when bringing the lock-up clutch into engagement.

6. An automatic transmission control device according to the claim 3, wherein
the electronic control device controls the electromagnetic control device such that the output pressure thereof is increased, when temperature of the working fluid becomes lower than a predetermined value.

7. An automatic transmission control device according to the claim 3, wherein
the electronic control device controls the electromagnetic control device such that the output pressure thereof is increased, when rotational number of the internal combustion engine is lower than a predetermined value.

8. An automatic transmission control device according to the claim 1, further comprising;
an operation decreasing device for decreasing operational speed of the capacity varying device.

9. An automatic transmission control device according to the claim 1, further comprising;
a relief valve provided in a pump discharge line into which the pump discharges the pressurized working fluid.

10. An automatic transmission control device for a vehicle comprising:
a pump of a capacity variable type, which is driven by an internal combustion engine of the vehicle and generates fluid pressure to be applied to friction elements of an automatic transmission device for changing a transmission gear;
a hydraulic pressure line connected to the pump;
a line pressure control device for controlling the fluid pressure of the hydraulic pressure line;
multiple electromagnetic valves connected to the hydraulic pressure line for generating output pressure based on the fluid pressure of the hydraulic pressure line, the output pressure being applied to the respective friction elements via a fixed orifice;
a selection device for selecting the maximum pressure among the output pressures of the multiple electromagnetic valves; and
an electronic control device for controlling operations of the electromagnetic valves,
wherein the maximum pressure selected by the selection device is applied to the line pressure control device, so that a fluid control pressure is generated by the line pressure control device depending on the maximum pressure and such fluid control pressure is applied to a capacity varying device of the pump, and
the electromagnetic valves are controlled to increase the output pressures when starting an operation of a transmission gear change, in such a manner that the output pressure is increased to a first pressure for a short period and then the output pressure is controlled at a second pressure which is lower than the first pressure.
